(19) United States
(12) Patent Application Publication
(10) Pub. No.: US 2024/0264603 A1
(43) Pub. Date: Aug. 8, 2024

(54) Assisted Navigation System for Assisted Automation of Mobile Robots

(71) Applicants: Andrés Felipe Chavez Cortes, El Cerrito, CA (US); Carlos Andres Alvarez Restrepo, Medellín (CO); Rafael Rincon, Medellín (CO); Salomon Granada Ulloque, Medellín (CO); Nicolás Rocha Pacheco, Bogotá (CO); Davidson Daniel Rojas Cediel, Medellín (CO); John Betancourt, Medellín (CO); Pedro Gonzalez, Envigado (CO); Wilmer David Garzón Cáceres, Medellín (CO)

(72) Inventors: Andrés Felipe Chavez Cortes, El Cerrito, CA (US); Carlos Andres Alvarez Restrepo, Medellín (CO); Rafael Rincon, Medellín (CO); Salomon Granada Ulloque, Medellín (CO); Nicolás Rocha Pacheco, Bogotá (CO); Davidson Daniel Rojas Cediel, Medellín (CO); John Betancourt, Medellín (CO); Pedro Gonzalez, Envigado (CO); Wilmer David Garzón Cáceres, Medellín (CO)

(21) Appl. No.: 18/435,882

(22) Filed: Feb. 7, 2024

Related U.S. Application Data
(60) Provisional application No. 63/483,707, filed on Feb. 7, 2023.

(51) Int. Cl. G05D 1/224; G05D 1/243; G05D 1/248; G05D 1/644; G05D 107/17

(52) U.S. Cl. CPC G05D 1/2247; G05D 1/2435; G05D 1/248; G05D 1/644; G05D 2107/17

(57) ABSTRACT

The assisted navigation system is intended to enable an assisted operation mode in ground mobile robots. The system is designed to achieve an autonomous relocation of a robot from one location to another location within a sidewalk, minimizing the need for constant human intervention. The system includes a camera for collecting the visual data needed to assess the terrain and potential obstacles, a collection of sensors to detect potential obstacles during assisted operations, a communication module to receive inputs from a remote operator to enable the activation of this system, a localization module for teleoperations, a local server module to store the information gathered, a processor configured to operate a robot in an assisted mode of operation based on input from the communication interface in which the robot performs a task without human intervention, and a communication interface coupled to the processor and configured to communicate control values to the systems of the mobile robot.

### FIELD OF THE INVENTION

The present invention relates generally to mobile robots operating in urban environments. More specifically, the invention relates to a system designed for sidewalk recognition by computer vision algorithms designed for assisted automation of mobile robots for increased safety of operations.

### BACKGROUND OF THE INVENTION

Integration of mobile robots into urban environments is increasing rapidly as technological improvements enable their use for commercial applications. Enhancement of autonomous and semi-autonomous capabilities is critical for their implementation in urban environments, as it reduces adoption costs and guarantees the safety of pedestrians in operation zones. This enhancement is done by improving the system and methods wherein mobile robots construct a virtual representation of their surroundings by using cameras, sensors, and computer vision algorithms to analyze and identify such settings.

Mobile robots navigating urban environments generally need to cross streets and driveways, areas which may require the intervention of a teleoperator to ensure the safety of the mobile robot. Technological capabilities in autonomous and semi-autonomous mobile robots are not advanced enough to prevent any potential accidents under such circumstances, thus requiring the intervention of a teleoperator to safely traverse any areas that may pose said risk.

The present invention addresses this issue by providing robotic platforms with an assistance teleoperation mode to navigate from one corner to the other, while remaining entirely within the sidewalk and dodging any potential obstacles and gives complete control of the navigation controls of the platform when encountered with a type of terrain that poses a higher degree of risk for assisted robotic operations, such as street crossings and driveways.

### SUMMARY OF THE INVENTION

Embodiments of the present invention relate to a sidewalk perception system to recognize and identify the terrain being traversed during assisted teleoperation of mobile robots. The main idea behind this invention is to grant assisted autonomous navigation capabilities to mobile robots so long as they remain within adequate terrain for routing. This system may be activated by the teleoperator of a mobile robot to enable autonomous pathing starting from one point to another, while evading potential obstacles with different technologies such as cameras, distance sensors, cliff sensors, LiDARs (light detection and ranging sensors), and/or stereo cameras and staying within the designated terrain for movement.

The areas of interest identified by the system correspond to sidewalks, driveways, and roads: areas where manned vehicles can travel. Said areas are of particular interest to identify due to the potential presence of high-speed vehicles or pedestrians or obstacles which may pose a threat to the mobile robot.

This system includes a camera for collecting the visual data needed to assess the terrain and potential obstacles; a collection of sensors to detect potential obstacles during autonomous operations; a communication module to receive inputs from a remote operator to enable the activation of this system; a localization module for teleoperations a local server module to store the information gathered; a processor configured to operate a robot in an assisted mode of operation, wherein the robot performs a task without human intervention; and a communication interface coupled to the processor and configured to communicate control values to the systems of the mobile robot.

### BRIEF DESCRIPTION OF THE DRAWINGS

FIG. 1 is a block diagram of the present invention, wherein thinner flowlines represent electrical connections between components, thicker flowlines represent electronic connections between components, and dashed flow lines indicate the components being communicably coupled.

FIG. 2 is a block diagram of the data collection unit.

FIG. 3 is a block diagram of the assisting module.

FIG. 4. is a block diagram that depicts an overview of the present invention's architectural framework, wherein important nodes of operation of the processor are illustrated.

FIG. 5 is a perspective view of a sidewalk that is finely outlined to build the required cost map and waypoints, according to the present invention.

### DETAIL DESCRIPTIONS OF THE INVENTION

All illustrations of the drawings are for the purpose of describing selected versions of the present invention and are not intended to limit the scope of the present invention.

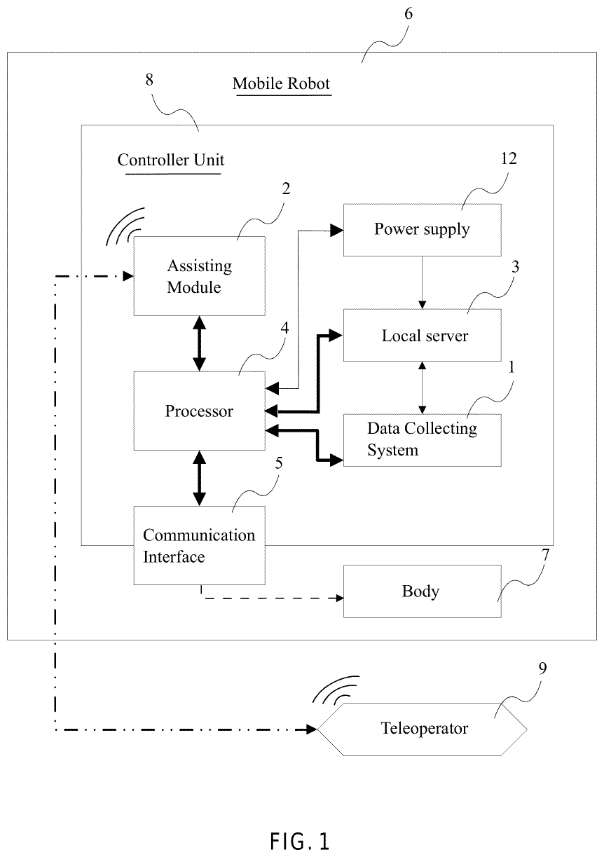

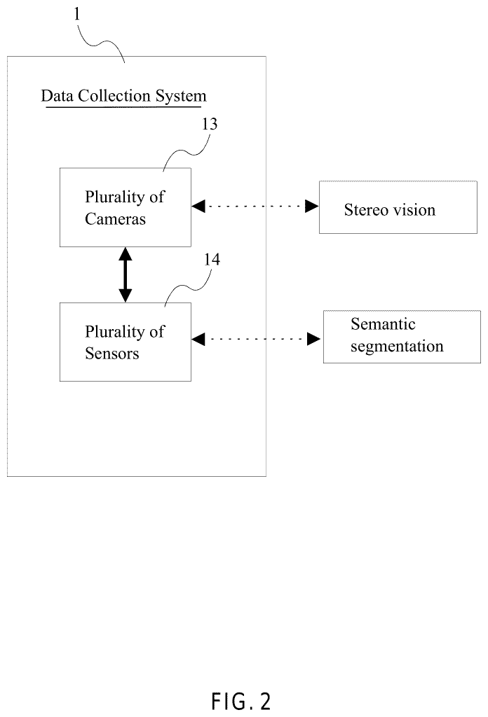

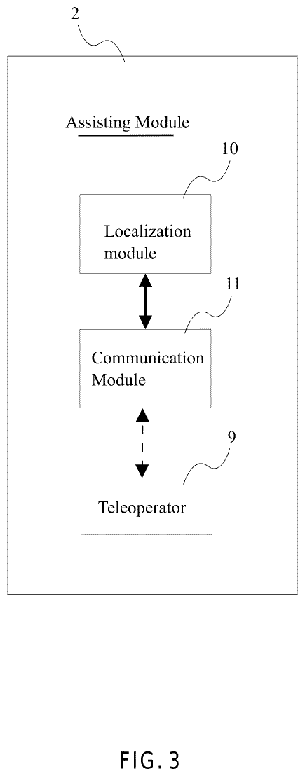

In reference to FIG. 1 through FIG. 5, the present invention is a system designed for sidewalk recognition by computer vision algorithms designed for assisted automation of mobile robots for increased safety of operations.

The following description is in reference to FIG. 1 through FIG. 5. According to a preferred embodiment, the present invention comprises a data collection system 1, an assisting module 2, a local server module 3, a processor 4, a communication interface 5, and a mobile robot 6. According to the preferred embodiment, the system enables autonomous pathing starting from one point to another point, while evading potential obstacles. To that end, the data collection system 1 constitutes a collection of devices enabled to collect information of the path that the mobile robot has to traverse. Example components of the data collection system 1 include but are not limited to different technologies and devices such as cameras, distance sensors, cliff sensors, LiDARs, stereo cameras, etc.

According to the preferred embodiment, the assisted navigation method consists of an alternate form of navigation designed to enable the mobile platform to traverse from one location to another without any additional inputs from a human operator. However, the system needs assistance for activation and human intervention to guarantee safe traversing through potentially dangerous crossing points such as street crossings, driveways, emergencies, etc. To that end, the assisting module 2 provides the necessary assistance and intervention when the supervisor decides to intervene because a risky condition may be close. Further, the local server module 3 enables users and the system to store all the information gathered from the data collection system 1 as well as the other components of the present invention.

In the preferred embodiment, the processor 4 is configured to operate a robot in an assisted mode of operation based on input from the communication interface in which the robot performs a task without human intervention. To that end, the data collection system 1, the assisting module 2, the local server module 3, and the communication interface 5 are electronically coupled to the processor 4. Preferably, the processor 4 is an integrated circuit that controls the operations of all the electric and electronic components of the present invention, based on the collected information and saved algorithms of the present invention.

Continuing with the preferred embodiment, the mobile robot 6 comprises a robot body 7 and a controller unit 8. Preferably, the robot body 7 comprises the moving parts of the mobile robot 6 and the controller unit 8 comprises a housing for all the electric and electronic components of the present invention. In other words, the data collection system 1, the assisting module 2, the processor 4, the local server module 3, and the communication interface 5 are mounted within the controller unit 8 of the mobile robot 6. It should be noted that the controller unit 8 and the robot body 7 may comprise any size, shape, components, arrangement of components, etc. that are known to one of ordinary skill in the art, as long as the intents of the present invention are fulfilled. Further, the communication interface 5 is coupled to the processor 4 and configured to communicate control values to the systems of the mobile robot 6. More specifically, the communication interface 5 is operably integrated between the processor 4 and the body 7 of the mobile robot 6, such that control values created by the processor 4 as well as the commands sent from the assisting module 2 are passed on to the body 7 through the communication interface 5.

A more detailed description of the present invention continues.

According to the preferred embodiment, the mobile robot 6 makes use of the systems managed by the controller unit 8 to identify the terrain being traversed and to ensure that it remains on the sidewalk. This sidewalk recognition enables the use of an assisted teleoperation mode, by which the mobile robot 6 may traverse from one corner to another without navigation inputs by a human operator through the control interface. This assisted navigation mode may be activated manually by the supervisor and/or automatically by the sidewalk recognition system. Furthermore, the system has the capability of identifying different types of terrain in order to enable the activation, and potential deactivation, of the assisted navigation mode. Accordingly, the assisting module 2 of the present invention comprises a teleoperator 9, a localization module 10, and a communication module 11. Preferably, the signals transferred from the teleoperator 9 to the processor 4 govern activation and deactivation of the mobile robot 6. To that end, the communication module 11 is communicably coupled between the teleoperator 9 and the processor 4, such that signals from the teleoperator 9 are transferred to the processor 4 through the communication module 11. More specifically, the communication module 11 is configured to receive inputs from a remote operator to enable the activation and/or deactivation of this system. Preferably, the communication module 11 is a wireless communication module. The wireless communication module 11 may be a wireless radio that connects and communicates with external devices via wireless data transmission protocols. Examples of which include, but are not limited to, Bluetooth, WI-FI, GSM, CDMA, and ZigBee. Further, the localization module 10 is used for determining the exact location of the mobile robot 6 during teleoperations. To accomplish this, the localization module 10 is communicably coupled with the processor 4. Preferably, the localization module 10 comprises a global positioning system (GPS) or a real time kinematic (RTK) positioning system. However, it should be noted that the assisting module 2 may comprise any other components, arrangement of components, technologies, combination of various technologies, etc. that are known to one of ordinary skill in the art, as long as the intended objectives of the present invention are fulfilled.

In order to provide electric power to the various components of the present invention, the system comprises a power source 12. Preferably, the power source 12 is a rechargeable battery that is mounted within the controller unit 8. However, the power source 12 may include any other sources of power, such as magnetic power, solar power, etc. that may be known to one of ordinary skill in the art, as long as the intents of the present invention are not hindered. Further, the power source 12 is electrically connected to the processor 4, such that electric power may be transferred to various other modules of the present invention through the processor 4.

In the preferred embodiment, the data collection system 1 comprises a plurality of cameras 13 and a plurality of sensors 14. The plurality of cameras 13 is used for collecting the visual data needed to assess the terrain and potential obstacles, and the plurality of sensors 14 is used to detect potential obstacles during assisted operations. Preferably, the plurality of cameras 13 comprises a front camera and a stereo camera. Using a semantic segmentation model, the processor 4 uses the images from the front and lateral cameras to provide pixelated vision of the buildings and obstacles near the sidewalk and categorizes each pixel into a category. The stereo camera not only gives an image but also the distance between an object and camera which helps with terrain identification, slopes, etc. Further, the plurality of sensors 14 comprises distance and cliff sensors that may be used to sense and thus avoid fixed or movable obstacles. However, it should be noted that, the data collection system 1 may comprise any other data collection devices that are known to one of ordinary skill in the art, as long as the intents of the present invention are fulfilled.

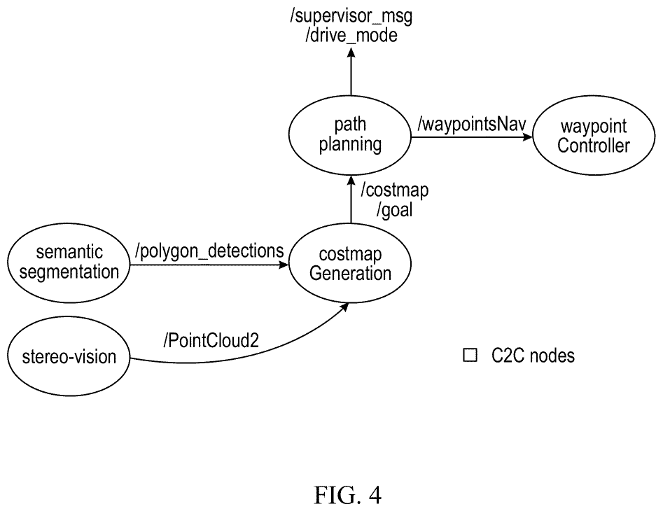

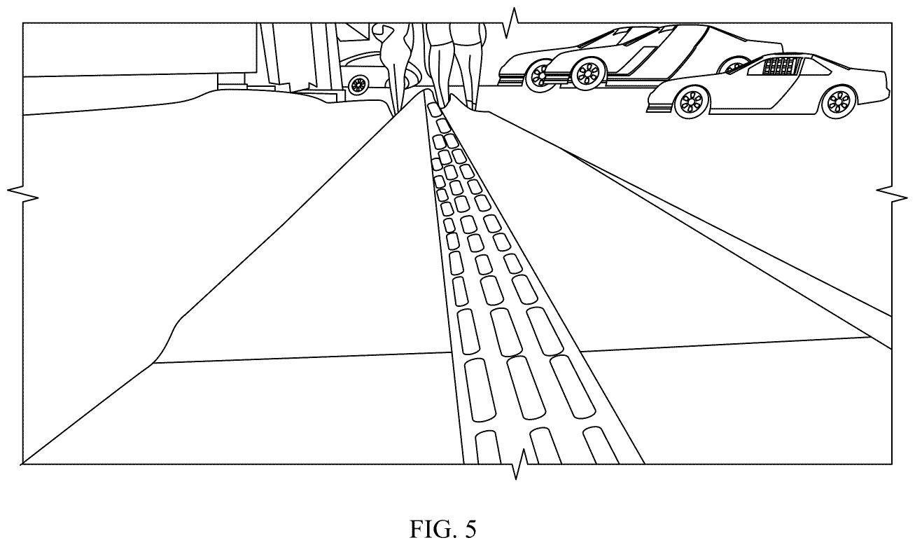

In reference to FIG. 4, a block diagram illustrating various nodes of operation of the processor 4 is shown. According to the preferred embodiment, two key nodes actuated by the processor 4 play a central role in the system's functionality. One is the cost map generation node and the second is the path planning node. In other words, the processor 4 generates a cost map and an optimal path for the mobile robot 6 based on the information collected by the data collection system 1 and the localization module 10. More specifically, the cost map generation node takes charge of formulating a cost map based on the segmented sidewalk data and point cloud information from the stereo camera. Additionally, it publishes a suggested goal position for the robot. Concurrently, the path planning node is responsible for identifying an optimal path to navigate through the cost map, utilizing an A* path planning algorithm. However, it should be noted that any path planning algorithm may be used by the processor 4, as long as the objectives of the present invention are not altered. Thus, the processor 4 and the data collection system 1, along with the localization module 10 create a cost map and path planning system for the mobile robot, wherein the data collection system enables sidewalk recognition by providing information for semantic segmentation and stereo vision. Subsequently, and in reference to FIG. 5, the processor 4 calculates a series of waypoints that are then transmitted to the Waypoint Controller node, responsible for producing the robot's movement. In other words, the processor 4 is communicably coupled with the communication interface 5 such that, waypoint controller nodes or way points received by the communication interface 5 navigate the mobile robot 6 in an assisted mode of operation.

Thus, the roles of semantic segmentation, cost map generation, path planning, and waypoint controller nodes form the core components of the processor 4, orchestrating the algorithms essential for successful traversal between locations. However, it is essential to acknowledge the presence of supplementary components. As previously mentioned, a supervisor or teleoperator 9 can assume control when intervention becomes necessary. For this reason, the path planning node publishes the supervisor message to alert the required intervention and the changing drive state of the robot between teleoperation and assisted mode.

Furthermore, the present invention is capable of identifying insecure, unsafe or uncertain conditions with the help of the controller unit 8, and relay information about the same to a cloud storage system, such that the current model may be retained and/or enhanced for future use.

Although the invention has been explained in relation to its preferred embodiment, it is to be understood that many other possible modifications and variations can be made without departing from the spirit and scope of the invention as hereinafter claimed.

What is claimed is:

1. An assisted navigation system for mobile robots comprising:
a data collection system;
an assisting module;
a local server module;
a processor;
a communication interface;
a mobile robot;
the mobile robot comprising a body and a controller unit;
the data collection system, the assisting module, the processor, the local server module, and the communication interface being mounted within the controller unit of the mobile robot;
the data collection system, the assisting module, the local server module, and the communication interface being electronically coupled to the processor; and
the communication interface being operably integrated between the processor and the body of the mobile robot, such that control values created by the processor are passed on to the body through the communication interface.

2. The assisted navigation system of claim 1, the assisting module comprising:
a teleoperator;
a localization module; and
a communication module;
the localization module being communicably coupled with the processor; and
the communication module being communicably coupled between the teleoperator and the processor, such that signals from the teleoperator are transferred to the processor through the communication module.

3. The assisted navigation system of claim 2, wherein the signals transferred from the teleoperator governs activation and deactivation of the mobile robot.

4. The assisted navigation system of claim 2, wherein the communication module is a wireless communication module.

5. The assisted navigation system of claim 2, wherein the localization module comprises a global positioning system (GPS).

6. The assisted navigation system of claim 2, wherein the processor generates a cost map and an optimal path for the mobile robot based on the information collected by the data collection system and the localization module.

7. The assisted navigation system of claim 1, comprising:
a power source;
the power source being mounted within the controller unit; and
the power source being electrically connected to the processor.

8. The assisted navigation system of claim 1, wherein waypoints received by the communication interface from the processor navigate the mobile robot.

9. The assisted navigation system of claim 1, wherein the data collection system comprises a plurality of cameras and a plurality of sensors.

10. The assisted navigation system of claim 9, wherein the plurality of cameras comprises a front camera and a stereo camera.

11. The assisted navigation system of claim 1, wherein the local server module stores data from the data collection system.

12. The assisted navigation system of claim 1, wherein the data collection system enables sidewalk recognition by providing information for semantic segmentation and stereo vision.

13. An assisted navigation system for mobile robots comprising:
a data collection system;
an assisting module;
a local server module;
a processor;
a communication interface;
a mobile robot;
the mobile robot comprising a body and a controller unit;
the assisting module comprising a teleoperator, a localization module, and a communication module;
the data collection system, the assisting module, the processor, the local server module, and the communication interface being mounted within the controller unit of the mobile robot;
the data collection system, the assisting module, the local server module, and the communication interface being electronically coupled to the processor;
the localization module being communicably coupled with the processor;
the communication module being communicably coupled between the teleoperator and the processor, such that signals from the teleoperator are transferred to the processor through the communication module; and
the communication interface being operably integrated between the processor and the body of the mobile robot, such that control values created by the processor are passed on to the body through the communication interface.

14. The assisted navigation system of claim 13, wherein the signals transferred from the teleoperator governs activation and deactivation of the mobile robot.

15. The assisted navigation system of claim 13, wherein the communication module is a wireless communication module.

16. The assisted navigation system of claim 13, wherein the localization module comprises a global positioning system (GPS).

17. The assisted navigation system of claim 13, wherein the processor generates a cost map and an optimal path for the mobile robot based on the information collected by the data collection system and the localization module.

18. The assisted navigation system of claim 13, comprising:
a power source;
the power source being mounted within the controller unit; and
the power source being electrically connected to the processor.

19. The assisted navigation system of claim 13, wherein waypoints received by the communication interface from the processor navigate the mobile robot.

20. The assisted navigation system of claim 13, wherein the data collection system comprises a plurality of cameras and a plurality of sensors.
